(19) United States
(12) Patent Application Publication
(10) Pub. No.: US 2008/0243641 A1
(43) Pub. Date: Oct. 2, 2008

(54) DISTRIBUTED POINTS OF SALE

(75) Inventor: Brian J. Leno, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: PHONE SHERPA, INC., Seattle, WA (US)

(21) Appl. No.: 12/058,477

(22) Filed: Mar. 28, 2008

Related U.S. Application Data
(60) Provisional application No. 60/908,641, filed on Mar. 28, 2007.

(51) Int. Cl. G06Q 30/00

(52) U.S. Cl. 705/27; 705/26

(57) ABSTRACT

A distributed point of sale can be accessed via any suitable tag-based document, such as a Web page, a blog, a piece of e-mail, or even an advertisement. Either a snippet of text or a graphical element, such as a button, can be selected by a buyer to cause a representation of the distributed point of sale to appear without causing a context of the tag-based document to change or navigate the buyer away from the tag-based document.

### CROSS-REFERENCE TO A RELATED APPLICATION

This application claims the benefit of U.S. Provisional Application No. 60/908,641, filed Mar. 28, 2007, which is incorporated herein by reference.

### BACKGROUND

To sell products/services over the Internet, sellers have few options. They can purchase a dedicated back end computer system to manage electronic commerce connected with a Web site that they maintain to facilitate transactions with buyers. This option is often a headache for many sellers because they lack the technical expertise to maintain and operate such a system. Another option is for them to leverage well-known electronic commerce Web sites, such as eBay Inc., to access the marketplace. Given the voluminous products and services at these well known Web sites, it is difficult for sellers to differentiate their products and services from other products and services.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present invention, a system form of the invention includes a system for facilitating electronic commerce, which comprises a client computer on which a distributed point of sale user interface is configured to execute by appearing to hover over a tag-based document or appearing to be embedded into the tag-based document, which is not owned by a seller, and to which a buyer navigates without having to further navigate the buyer to another tag-based document so as to facilitate purchase of a product/service by the buyer at the tag-based document.

In accordance with another aspect of the present invention, a method form of the invention includes a method for facilitating electronic commerce, which comprises receiving a selection by a buyer on either a hyperlink or a graphical element on a tag-based document that evinces an intention to purchase a product/service. The method further comprises presenting a distributed point of sale user interface which appears to hover over the tag-based document or appears to be embedded into the tag-based document, which is not owned by a seller, and to which the buyer navigates without having to further navigate the buyer to another tag-based document so as to facilitate purchase of the product/service by the buyer at the tag-based document.

In accordance with another aspect of the present invention, a computer-readable medium form of the invention includes a computer readable medium having computer-executable instructions stored thereon for implementing a computer-executable method for facilitating electronic commerce, which comprises emitting a piece of text that is executable to invoke a distributed point of sale user interface in response to a request for creating a product/service by a seller. The method further comprises transmitting pieces of information about the product/service to the distributed point of sale user interface which appears to hover over a tag-based document or appears to be embedded into the tag-based document, which is not owned by the seller, and to which the buyer navigates without having to further navigate the buyer to another tag-based document so as to facilitate purchase of the product/service by the buyer at the tag-based document.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary network for facilitating distributed points of sale;

FIGS. 2A-2C are pictorial diagrams illustrating exemplary tag-based documents and an exemplary distributed point of sale user interface which hovers over a tag-based document;

FIG. 3A is a pictorial diagram illustrating an exemplary tag-based document;

FIG. 3B is a textual diagram illustrating exemplary signatures of functions within an exemplary library for facilitating a distributed point of sale user interface;

FIG. 3C is a textual diagram illustrating an exemplary function, which invocation creates an exemplary distributed point of sale user interface;

FIG. 3D is a textual diagram illustrating pieces of text, which selection may invoke an exemplary distributed point of sale user interface;

FIG. 4 is a communication diagram that illustrates communications among exemplary actors for facilitating a distributed point of sale user interface;

FIG. 5 is a pictorial diagram illustrating an exemplary unified shopping cart experience; and

FIGS. 6A-6J are process diagrams illustrating an exemplary method for facilitating distributed points of sale software over the Internet.

### DETAILED DESCRIPTION

Various embodiments of the present invention facilitate sellers to sell their products/services on any tag-based documents without the need to have an electronic shopping cart or billing user interface integrated into a system that hosts the tag-based documents. In other words, various embodiments of the present invention facilitate distributed points of sale for quickly implementing a seller's desire for a solution to his electronic commerce retail needs and allowing the sale of his products or services in the context of a tag-based document, such as a Web site, that does not belong to the seller. Hence, a seller can sell products or services on someone else's personal Web site, blog, or product review site. The buyer can purchase the products or services using a distributed point of sale user interface without leaving a tag-based document, such as a Web page, to which he has navigated. In one embodiment, a piece of text is accommodated by a host page, which houses a tag-based document, to initiate purchase of a desired product/service. Any suitable piece of text can be used as long as the piece of text is a line of tag-based expression that can invoke a named collection of code to present a distributed point of sale user interface. Besides Web pages, other suitable tag-based documents include advertisements, pieces of e-mail, and blogs for facilitating purchases of products/services anywhere the seller desires to sell.

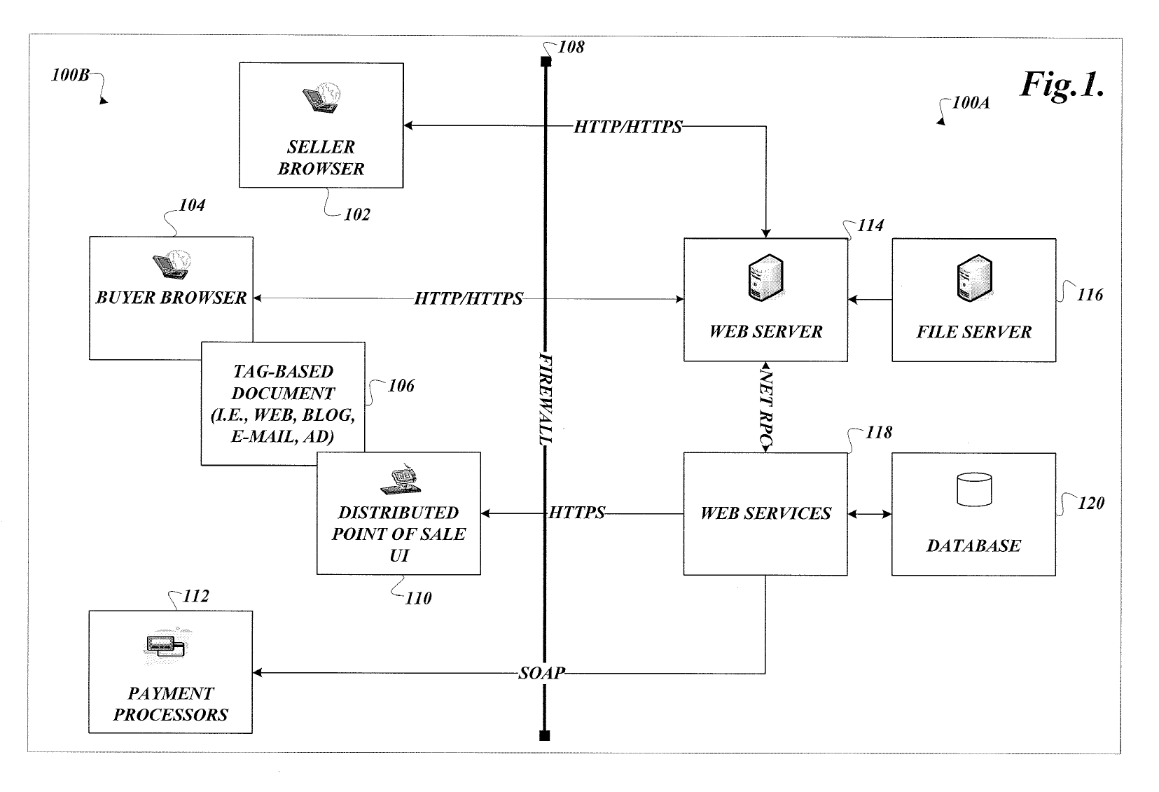

FIG. 1 illustrates an exemplary network for facilitating distributed points of sale over any communications medium, including the Internet. A front end portion 100b of the network includes various client machinery that may communicate with a back end portion 100a of the network via a firewall 108. The firewall 108 is a security system that protects one network against threats of unauthorized accesses coming from another network. The firewall 108 suitably is a combination of hardware and software preventing computers inside a network from directly communicating with computers outside of the network and vice versa.

The front end portion 100b includes a seller browser 102 through which a seller accesses the back end portion 100a, which includes a seller Web site managing distributed points of sale over the network. The seller, using the seller browser 102, may access, for example, a Web server 114 to manage distributed points of sale. For example, the seller may implement a distributed point of sale by creating an account with the seller Web site, adding product/service information, such as title, image, description, price, and so on, to his account for each product/service he wishes to sell. The Web server 114 emits pieces of text, which function like macros that the seller can embed into any tag-based document, such as Web sites, blogs, pieces of e-mail, advertisements, and so on. The back end portion 100a responds to indications of product purchases from the distributed point of sale user interface and notifies the seller to fulfill product delivery to the buyer.

The Web server 114 responds to requests from the seller browser 102 or a buyer browser 104 to access a group of related tag-based documents and associated files, scripts, and databases, such as a file server 116, that facilitates electronic commerce through distributed points of sale over the Internet. The tag-based documents accessible through the Web server 114 cover topics that are related to the distributed points of sale. A home page is made available by the Web server 114 as a starting point, which frequently functions as a table of contents for the seller to manage his account and products/services being offered through his account to various distributed points of sale. The file server 116 includes a file-storage device on the back end portion 100a that is accessible by the Web server 114 and suitably is a sophisticated device that not only stores files but manages them and maintains order as the Web server 114 requests files and makes changes to them in accordance with the requests from the seller and other sellers.

The front end portion 100b includes the buyer browser 104, which includes software that lets a buyer view tag-based documents and access files and software related to those documents, such as code libraries supporting distributed points of sale by communicating with the Web server 114. A distributed point of sale, in various embodiments of the present invention, can be accessed via any suitable tag-based document 106, such as a Web page, a blog, a piece of e-mail, or even an advertisement. Either a snippet of text or a graphical element, such as a button, can be selected by the buyer to cause a representation of the distributed point of sale, such as a distributed point of sale user interface 110, to appear without causing a context of the tag-based document 106 to change. In other words, various embodiments of the present invention refrain from navigating the buyer away from the tag-based document 106, such as a Web site, the buyer was viewing, to another Web site that accommodates electronic commerce. Instead, various embodiments of the present invention present a distributed point of sale, such as the distributed point of sale user interface 110 that hovers over the tag-based document 106, without navigating the buyer to other Web sites. However, in various other embodiments of the present invention, the distributed point of sale, such as the distributed point of sale user interface 110 appears embedded (not hovered) into the tag-based document 106, without navigating the buyer to other Web sites.

The distributed point of sale user interface 110 communicates with Web services 118 via any suitable secured protocols, such as the HyperText Transfer Protocol Secure (HTTPS), which is a variation of HTTP that provides for encryption and transmission through a secure port, which mechanism is known as the Secure Sockets Layer. Because the distributed point of sale user interface 110 is an instantiation within the back end portion 100a of the network, the security policy of the back end portion 100a automatically extends to the distributed point of sale user interface 110, allowing for secure transmission of information regarding electronic commerce transactions without the seller having to separately procure a license to communicate transactions securely between the front end 100b and the back end 100a.

The distributed point of sale user interface 110 allows the buyer to complete a purchase transaction of products/services mentioned in the tag-based document 106 in one embodiment. In other embodiments, the buyer need not complete any purchasing transactions via the distributed point of sale user interface 110 but may cause the distributed point of sale user interface 110 to remember the selected products/services of interest by using one or more tokens that are stored by the front end 100b to facilitate later purchases. In various embodiments, the distributed point of sale user interface 110 may access these tokens to remind the buyer of previously selected but not purchased products/services at the next presentation of the distributed point of sale user interface 110. In other embodiments, the distributed point of sale user interface 110 may present products/services that were not purchased by the buyer but previously selected at other tag-based documents at other sites, thereby facilitating a unified shopping experience for the buyer.

A database 120 stores unique product/service identifiers and their relationship to various sellers' accounts as well as other pieces of information, such as names of products/services, descriptions, prices, and so on. The database 120 is accessible by the Web services 118 to gather these pieces of information for presentation by the distributed point of sale user interface 110 to the buyer. When the buyer has provided payment information, such as credit card information, to the distributed point of sale user interface 110, such pieces of information in turn are provided to the Web services 118 and which are communicated to payment processors 112 for their consideration to commit to the transaction.

In an embodiment where dynamic HTML (DHTML) and JAVASCRIPT® are used, a dynamic tag-based language harness, such as DHTML, contains a distributed point of sale user interface which appears to hover or appears to be embedded, providing a current context of the buyer without navigating the buyer away to other Web sites. A scripting language library, such as JAVASCRIPT, is suitably used to contain helper functions for easing the implementation of the distributed points of sale for sellers and host environments. In this embodiment, a common Web service API is provided to allow uniform interfaces with the Web services 118 to facilitate seller administration to configure products/services for sale; payment processor integration for facilitating funds transfer between buyers and sellers; database services for providing storage regarding transactions, products, sellers, buyers, and so on; and server logic to manage the point of sale process including reporting, billing, seller notifications, and so on.

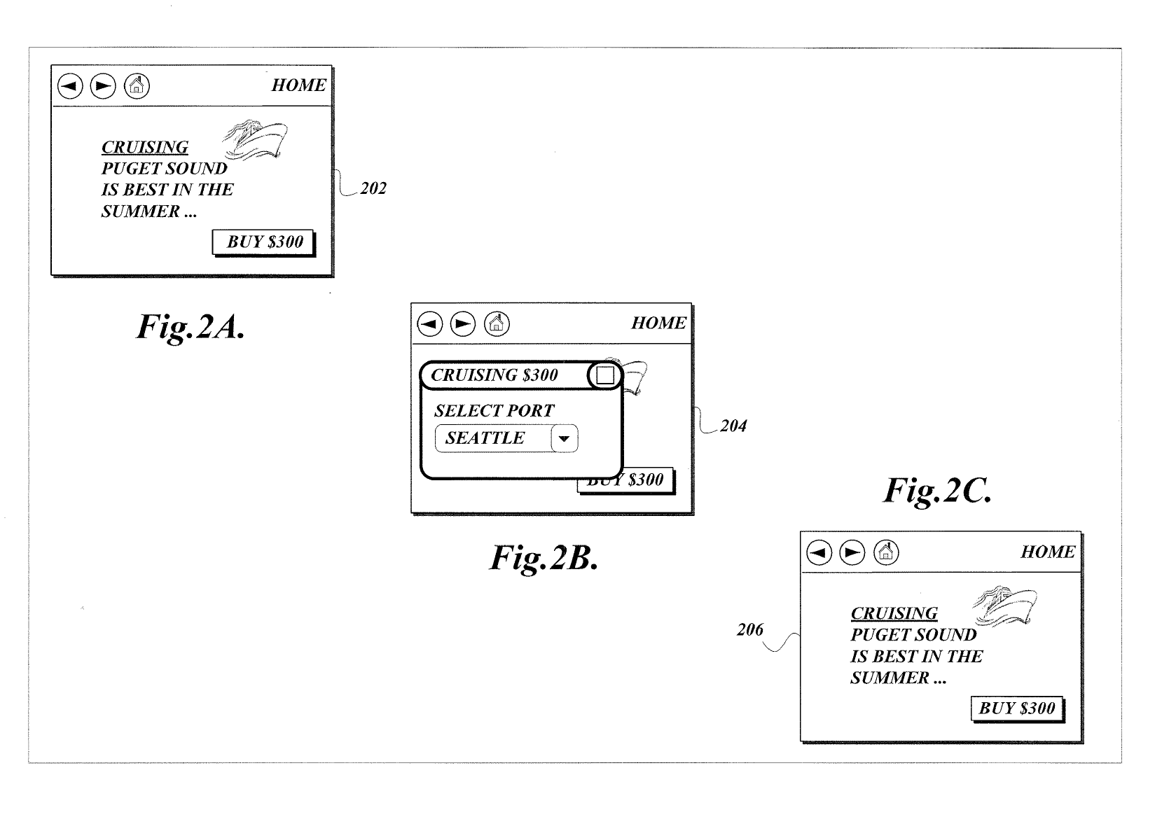

FIG. 2A illustrates an application 202, which is a piece of software that interprets tag-based documents, such as a browser, allowing a buyer to view tag-based documents and access files and software related to those documents. The application 202 includes a toolbar, which is a horizontal space at the top of a window that contains a number of buttons in iconic form to allow the buyer to access various tag-based pages, formed from a total set of interlinked hypertext documents residing on servers. A button, which appears as a left-pointing arrow enclosed by a circle, allows the buyer to move backward through a history of displayed tag-based pages. Another button, which appears as a right-pointing arrowhead enclosed in a circle, allows the buyer to advance to new tag-based pages previously undisplayed. A third button is a HOME button that appears as a simple house enclosed in a circle, which returns the buyer to a home page when clicked upon. Appearing in the right corner of the toolbar is the name of the page, which in this instance is “HOME.”

A frame defines a rectangular section of the application 202, which is subjacent to the toolbar and allows tag-based pages to be displayed. Tag-based pages are written in tag-based languages, such as HyperText Markup Language, identified by URLs (Uniform Resource Locators) that specify a particular machine and a path name by which a file can be accessed and transmitted from servers to the application 202 using a tag-based protocol, such as the HyperText Transfer Protocol. In the illustrated instance, the frame displays an on-line article, which is a composition forming an independent part of an on-line publication. A portion of the article appears as “cruising Puget Sound is best in the summer . . . ” The underlined text “CRUISING” is a hyperlink that can be selected by the buyer to cause the distributed point of sale user interface 110 to hover above the application 202 in one embodiment. In other embodiments, a graphical element, such as a button titled “BUY $300,” when selected by the buyer causes the distributed point of sale user interface 110 to appear hovered over the application 202 or appears to be embedded into the application 202, without navigating the buyer away from his current context.

FIG. 2B illustrates another point in later time, in which application 202 is now renumbered as application 204, and in which elements are similar to those of the application 202 illustrated in FIG. 2A. For brevity purposes, these similar elements will not be repeated here. FIG. 2B illustrates an instance of time after the buyer has either selected the hyperlink “CRUISING” or the button “BUY $300” to cause the distributed point of sale user interface 110 to appear above the application 204. The distributed point of sale user interface 110 hovers over the application 204, although in other embodiments the distributed point of sale user interface 110 appears embedded into the application 204. The distributed point of sale user interface 110 includes a toolbar as a horizontal space at the top and contains the name of the goods/services under consideration by the buyer, which in this instance is “CRUISING $300.” Appearing to the right corner of the toolbar of the distributed point of sale user interface 110 is a check box enclosed in a circular region that, when selected by the buyer, will dismiss the distributed point of sale user interface 110, returning the buyer to the original context of the tag-based document, such as the application 202 renumbered as application 206 illustrated at FIG. 2C. A frame defines a rectangular section of the distributed point of sale user interface 110, which is subjacent to the toolbar, and allows details of the goods/services, including billing information, to be displayed.

In the illustrated instance, the frame of the distributed point of sale user interface 110 displays a selection entitled “SELECT PORT” in which a drop-down menu allows the buyer to specify a port from which he will board to begin his boating trip. Below, the drop-down menu with a default selection of “SEATTLE” appears but will present a fuller menu when a downward pointing arrowhead is selected by the buyer to access other ports of other cities available to the drop-down menu. When the buyer has finished with the distributed point of sale user interface 110, the distributed point of sale user interface 110 disappears, returning the buyer to the original context of the tag-based document. FIG. 2C illustrates the application 206 containing many similar elements to the application 202 and, for brevity purposes, they will not be repeated here. FIG. 2C illustrates a point in time later after the distributed point of sale user interface 110 has been dismissed.

In an embodiment where DHTML and JAVASCRIPT® are used, a host Web page has a piece of text embedded into a click functionality of an HTML “BUY $300” button. When the “BUY $300” button is pressed, client-side JAVASCRIPT causes a DHTML window to appear within the host Web page and does not navigate the buyer to a new Web page. The JAVASCRIPT code, which invokes the DHTML window, includes a parameter with a unique product identifier associated with the “BUY $300” button. This facilitates the purchase of a particular product/service when the “BUY $300” button is pressed. The DHTML window hosts a rich interactive user interface for billing and purchase of a particular product/service (as specified by a unique product identifier). The buyer interacts with the distributed point of sale user interface and completes the purchase. After completing the purchase, the distributed point of sale user interface is dismissed. This closes the DHTML window within the host Web page. The buyer is returned to a starting state of the host Web page that existed before the purchase process began. The seller is notified of the purchase and uses his own methods for fulfilling the purchased product/service.

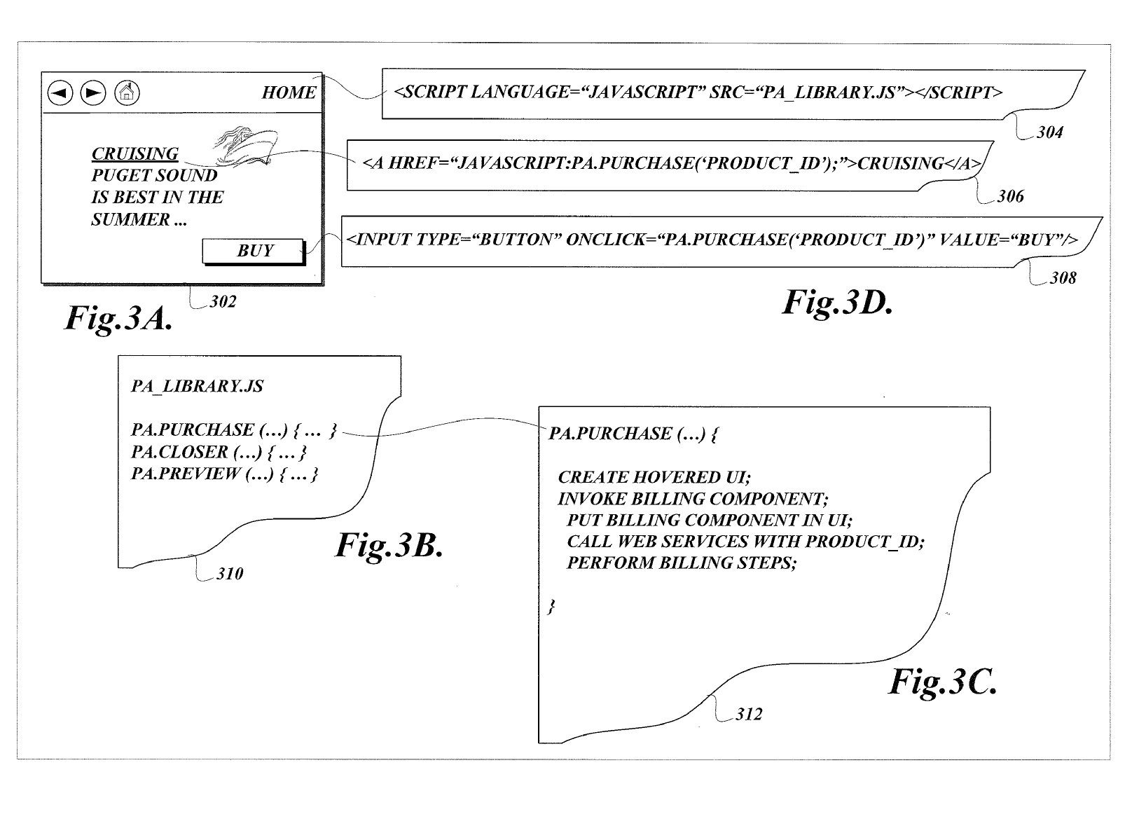

FIG. 3A illustrates an application 302, which has many similar elements as previously described in connection with the application 202 (illustrated by FIG. 2A), and for brevity purposes, they will not be repeated. FIG. 3D illustrates pieces of text emitted by the back end portion 100a in an embodiment where JAVASCRIPT® is used to implement various ways to invoke the distributed point of sale user interface 110. A piece of text 304 is expressed as <SCRIPT LANGUAGE=“JAVASCRIPT” SRC=“PA_LIBRARY.JS”></SCRIPT>”. The piece of text 304 is a directive that defines a path to a library containing functions that create the distributed point of sale user interface 110. Suitably, the piece of text 304 is embedded into a source file that comprises the application 302.

The piece of text 304 includes a term <SCRIPT that indicates a beginning of a tag-based directive that is named SCRIPT, which is used to customize or add interactivity to tag-based documents, such as Web pages. The piece of text 304 includes an attribute LANGUAGE for storing a specified artificial language connected with the script program. An equal sign “=” indicates an assignment of a particular artificial language to the attribute LANGUAGE, which assignment value is specified to the right of the equal sign “=”. The term JAVASCRIPT indicates that the language to be used to interpret the script program is the JAVASCRIPT language. The attribute SRC=indicates the nomenclature of a JAVASCRIPT library to be used and the equal sign “=” indicates readiness for the receipt of the script library specification. The term “PA_LIBRARY.JS” indicates the name of the library and its suffix “JS” specifies that the library is formed from JAVASCRIPT®. The symbol > indicates the end of the definition for the tag SCRIPT. And the term “</SCRIPT>” indicates termination of the tag SCRIPT.

FIG. 3D also illustrates another piece of text 306 emitted from the back end portion 100a that the buyer may insert into the source that forms the content of a tag-based document being rendered by the application 302. In the illustrated instance, the piece of text 306 is a basis for the hyperlink “CRUISING” which can be selected by the buyer to invoke the distributed point of sale user interface 110 to hover over the application 302 or appears to be embedded into the application 302 without navigating the buyer away from the application 302 and its tag-based document context. The piece of text 306 includes a beginning tag “<A” that indicates a tag called A is to be defined; an attribute “HREF” which indicates a definition of the hyperlink “CRUISING”; the equal sign “=” which indicates a potential assignment of a hypertext reference to the attribute HREF; a term “JAVASCRIPT®:” which indicates that a function to follow the colon “:” is to be found in a JAVASCRIPT library; the term “PURCHASE(” which indicates that the name of the function is PURCHASE and the open parentheses which indicates a beginning of signature for receiving a list of parameters to be sent into the function called PURCHASE; the term ‘PRODUCT_ID’), which indicates a parameter defining a unique product identifier connected with the selection of the hyperlink and the closed parentheses which indicates a termination of the signature for the function PURCHASE; the symbol “>” that indicates the end of the definition for the tag “<A”; the term CRUISING that indicates the name of the hyperlink “CRUISING” and appears visible to the buyer; and the term “</A>” that indicates the termination of the tag “<A.”

FIG. 3D additionally illustrates a piece of text 308 that creates a graphical element, such as a button entitled “BUY $300” appearing in the application 302. The piece of text 308 includes a term “<INPUT” that defines a beginning of an INPUT tag; an attribute “TYPE” that indicates the type of graphical element to be displayed in the application 302; an equal sign “=” that indicates an assignment to the TYPE attribute; the term “BUTTON” that indicates the graphical element to be presented to the buyer would be a button; an attribute ONCLICK that indicates an action to be taken after the buyer has selected the button; an equal sign “=” that indicates an assignment of the action upon the event of selecting the button; the term “PA.PURCHASE(‘PRODUCT_ID’)” that indicates the invocation of a function called PA.PURCHASE along with a parameter PRODUCT_ID that uniquely identifies a particular good/service being purchased by the buyer; an attribute VALUE that defines the title “BUY” of the button; and the symbol /> that indicates a termination of the expression of the INPUT tag.

FIG. 3B illustrates a portion 310 of a JAVASCRIPT® library “PA_LIBRARY.JS” that supports the functionality of the distributed point of sale user interface 110. Various function signatures are provided within the library, such as the function signature “PA.PURCHASE ( . . . ) { . . . }.” Other function signatures are also provided, including a function signature “PA.CLOSER ( . . . ) { . . . } and PA.PREVIEW ( . . . ) { . . . }. FIG. 3C illustrates a portion 312 of the pseudocode of the function PA.PURCHASE in greater detail.

The function signature PA.PURCHASE ( . . . ) { indicates a beginning of a named collection of instructions for the function PA.PURCHASE. A piece of the pseudocode indicates the creation of the distributed point of sale user interface 110 that hovers over the tag-based document or appears to be embedded into the tag-based document, or in the illustrated instance, the application 302. Next, another piece of the pseudocode indicates that a billing component is invoked for facilitating the purchasing of a particular good/service by the buyer. Various steps connected with the invocation of the billing component include putting the billing component inside the distributed point of sale user interface 110, and calling Web services 118 with a particular product identifier upon selection of either the hyperlink or the button “buy” in the application 302 by the buyer. Various billing steps are then performed, such as receiving Visa numbers, shipping address, and so on.

In one embodiment where DHTML and JAVASCRIPT® are used, the distributed point of sale is invoked by some action taken by the buyer on things such as HTML links or buttons. Any suitable user interface component that can raise an event to trigger the execution of JAVASCRIPT code can be used to cause the distributed point of sale user interface to appear. This allows deployment of any HTML design or layout that can accommodate the distributed point of sale user interface. Integration by the host, such as the application 302, requires the following: the host page includes reference to a JAVASCRIPT helper library of functions. See the piece of text 304. In an alternate embodiment, these library functions could also be written inline to a Web page but, for convenience, a library is suitably used. The host page also includes JAVASCRIPT calls to specific PA functions, most notably the PA.PURCHASE(PRODUCT_ID) function. See the portion 312. The PA.PURCHASE( . . . ) function can be written inline to an HTML source as dictated by a desired layout. Typically, an HTML layout is composed in a product-catalog like fashion or similar purchase-oriented design. Buttons for buying specific products/services would each have a PA.PURCHASE(PRODUCT_ID) function with a unique product/service identifier corresponding to the product/service being purchased. When a button/link is clicked, the JAVASCRIPT® text is executed. See pieces of text 306, 308. The appropriate function inside the library is invoked for the specific PRODUCT_ID in the button/link. Inside the PA.PURCHASE( . . . ) function, a DHTML window is created inside the current Web page context, a FLASH® billing component is embedded within the DHTML window, and the FLASH billing component is initialized with the PRODUCT_ID, hence initiating a purchase of the specified product/service. Following completion of the purchase activity, the DHTML window is dismissed and the buyer is returned to the same Web page from which the process was initiated.

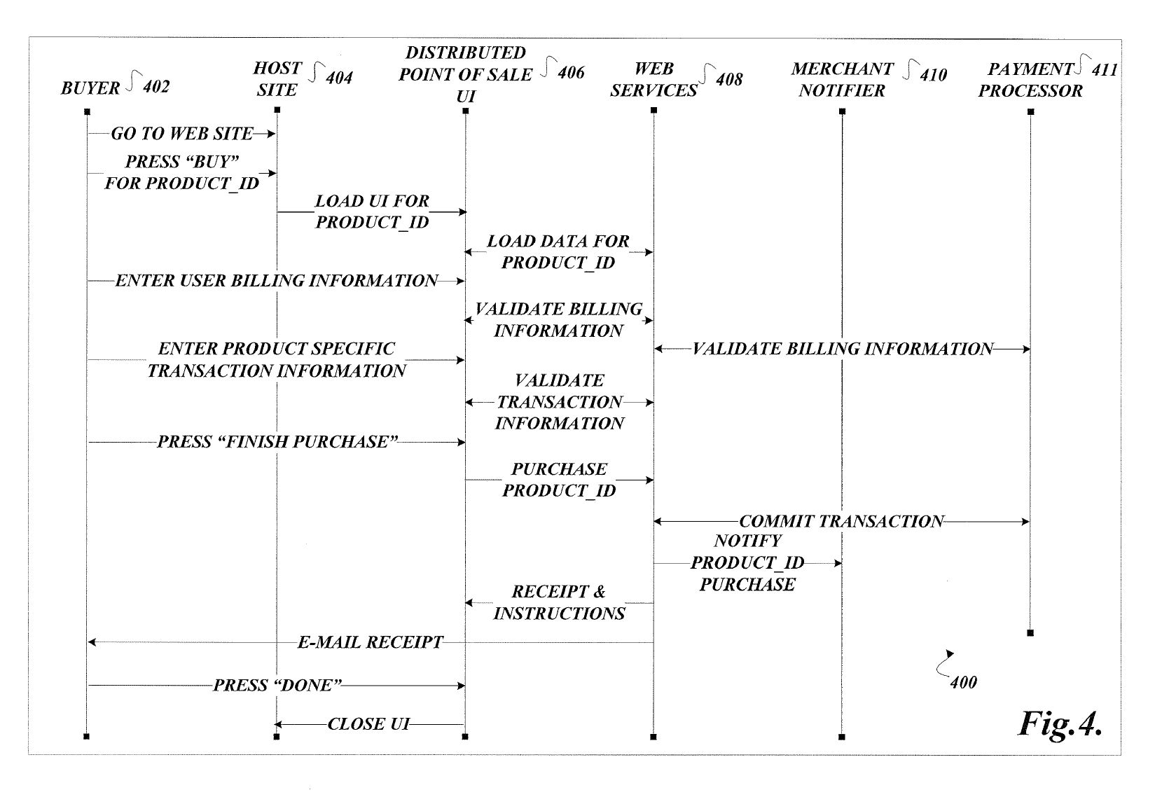

FIG. 4 illustrates a communication diagram 400 among a number of actors such as a buyer 402, a host site 404, a distributed point of sale user interface 406, Web services 408, a merchant notifier 410, and a payment processor 411. In the embodiments connected with the communication diagram 400, the focus is on the invocation of the distributed point of sale user interface 406 over a tag-based document, such as a Web page, but various communications can be reused for other types of tag-based documents besides Web pages, such as blogs, pieces of e-mail, and advertisements.

Initially, the buyer 402 accesses a Web site housed by the host site 404. After navigating to the host site 404, the buyer may encounter hyperlinks or graphical elements that are selectable to cause the host site 404 to receive indication of an intention to buy a product/service connected with a particular product identifier. Next, the host site 404 loads the distributed point of sale user interface for the particular product/service connected with the product identifier. The distributed point of sale user interface 406 hovers over a current context of the host site 404 or appears to be embedded into the current context of the host site 404 without navigating the buyer away from such current context. At the same time, the distributed point of sale user interface 406 communicates with the Web services 408 to load data connected with the particular product/service product identifier.

In an embodiment where FLASH® technology is used, the distributed point of sale user interface suitably is implemented in FLASH, which serves to present the buyer 402 with an interactive user interface to complete a transaction and to communicate with the Web services 408 to facilitate buyer information validation, payment processing, and notification of purchase to the seller. The FLASH implemented distributed point of sale user interface is embeddable inside any Web page. The distributed point of sale user interface runs within a wide variety of host environments. In one embodiment, the distributed point of sale can be embedded within tag-based, such as HTML, pages to be displayed in standard Web browsers. The distributed point of sale user interface includes user interface screens to capture buyer information, credit card information, or phone billing information, legal consent, and promotional or discount codes/coupons.

The distributed point of sale user interface 406 leads the buyer 402 to various screens of the user interface, allowing the buyer 402, for example, to enter user billing information, and so on. The user billing information is communicated to the Web services 408, which in turn validates the billing information and communicates such a validation with the distributed point of sale user interface 406. Additionally, the Web services 408 communicates with the payment processor 411 to validate billing information that the Web services 408 cannot easily validate. The payment processor 411, in turn, communicates with the Web services 408 and provides validation information connected with the billing information provided by the buyer 402. Next, the distributed point of sale user interface 406 leads the buyer 402 to various screens of the user interface to enter product specific transaction information. The Web services 408 receives such product specific transaction information and validates such transaction information. To complete the purchase, the buyer 402 indicates that he wishes to finish purchasing the product/service to the distributed point of sale user interface 406.

The distributed point of sale user interface 406 communicates the purchase intention connected with the particular product/service product identifier through the Web services 408. The Web services 408 communicates payment information and requests the payment processor 411 to commit the transaction. The payment processor 411 indicates whether or not it can commit the transaction and notifies the Web services 408. If successful, the Web services 408 notifies the seller via the merchant notifier 410 that the particular product/service connected with the corresponding product identifier has been purchased, allowing the seller to fulfill the purchased product/service. The Web services 408 then provides receipt and additional instructions to the distributed point of sale user interface 406, which in turn presents such information to the buyer 402. Additionally, the Web services 408 suitably e-mails the receipt of such a purchase to the buyer 402. The buyer 402 indicates an intention to terminate the distributed point of sale user interface 406 by pressing a “done” user interface element on the distributed point of sale user interface 406. The distributed point of sale user interface 406 then terminates and removes itself from the host site 404, allowing the previous context to be restored for the buyer 402.

In various embodiments of the present invention, the distributed point of sale user interface 406 includes an ability to connect via any suitable Web service protocols (such as SOAP) to the Web services 408. The Web services 408 include, but are not limited to, the following: services for retrieving product information (e.g., name, description, price, and images); services for retrieving localized text for the distributed point of sale user interface; services for retrieving localized monetary currency; services for processing promotional or discount codes; services for validating buyer information, such as proper e-mail format or credit card AVS check; services for payment processing via payment processor or “bill cell phone” via carrier; services for processing payout calculations for seller revenue share of transactions; services for notifying the seller that a product/service was purchased; and services for executing delivery of receipt information to the buyer.

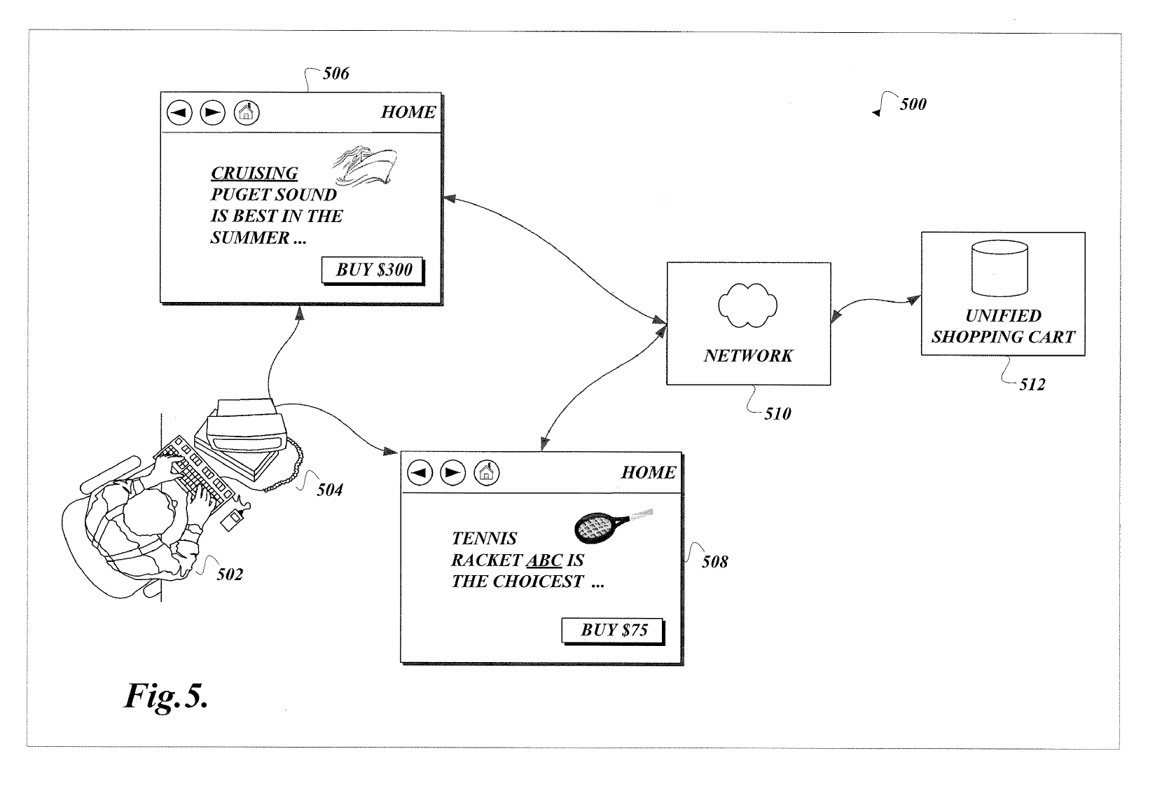

FIG. 5 illustrates embodiments of the invention connected with a unifying shopping experience for a buyer 502 using a system 500. The buyer 502 may use his or her client computer 504 to access tag-based documents 506, 508. Tag-based documents 506, 508 include elements similar to those previously discussed connected with the application 202 of FIG. 2A, and they shall not be repeated here for brevity purposes. Various links and graphical elements, such a buttons, are available for the buyer 502 to select to indicate an intention to purchase products/services. In the instance of the tag-based document 506, the goods/services that would be purchased by the buyer 502 consists of a boat cruise for about $300. In the instance of the tag-based document 508, upon selection of a hyperlink “ABC” or the button “BUY $75,” the buyer would be purchasing a tennis racket.

The tag-based documents 506, 508 may belong to a particular Web site, or each of them may be part of different Web sites. The buyer 502 may not desire to immediately complete the purchasing decision in regard to the products/services presented by the tag-based documents 506, 508 and, in that instance, the system 500 stores the purchasing intentions of the buyer 502 as tokens or cookies on the client computer 504 so that at the next invocation of the distributed point of sale user interface, the distributed point of sale user interface may re-present the previously selected but not purchased goods/services by the buyer 502. The management of such a unified commerce experience is monitored by a unified shopping cart 512 as part of the back end 100a and communicates through a network 510, such as a Wide Area Network or the Internet.

Thus, suitable purchases of multiple items via the unified shopping cart 512 are possible. Although the distributed point of sale can be used to buy a single product/service on demand, it can be extended to include purchasing multiple items concurrently. This ability facilitates the purchase of multiple items from one seller or multiple sellers. This unified shopping cart experience can be provided where disparate sellers and products/services can be purchased using one buyer billing/purchase experience. In one exemplary scenario, a buyer goes to seller A's Web site and activates a distributed point of sale for product 1; the buyer decides to add product 1 to a list of items to purchase but does not complete a transaction; the buyer then goes to seller B's Web site and activates another distributed point of sale for product 2; the buyer sees a list containing both product 1 and product 2; the user decides to purchase product 1 and product 2 at the same time; and this is facilitated by the unified shopping cart 512 of various embodiments of the present invention. The buyer makes a unified payment from his perspective, but seller A and seller B get separate payments and fulfillment notifications.

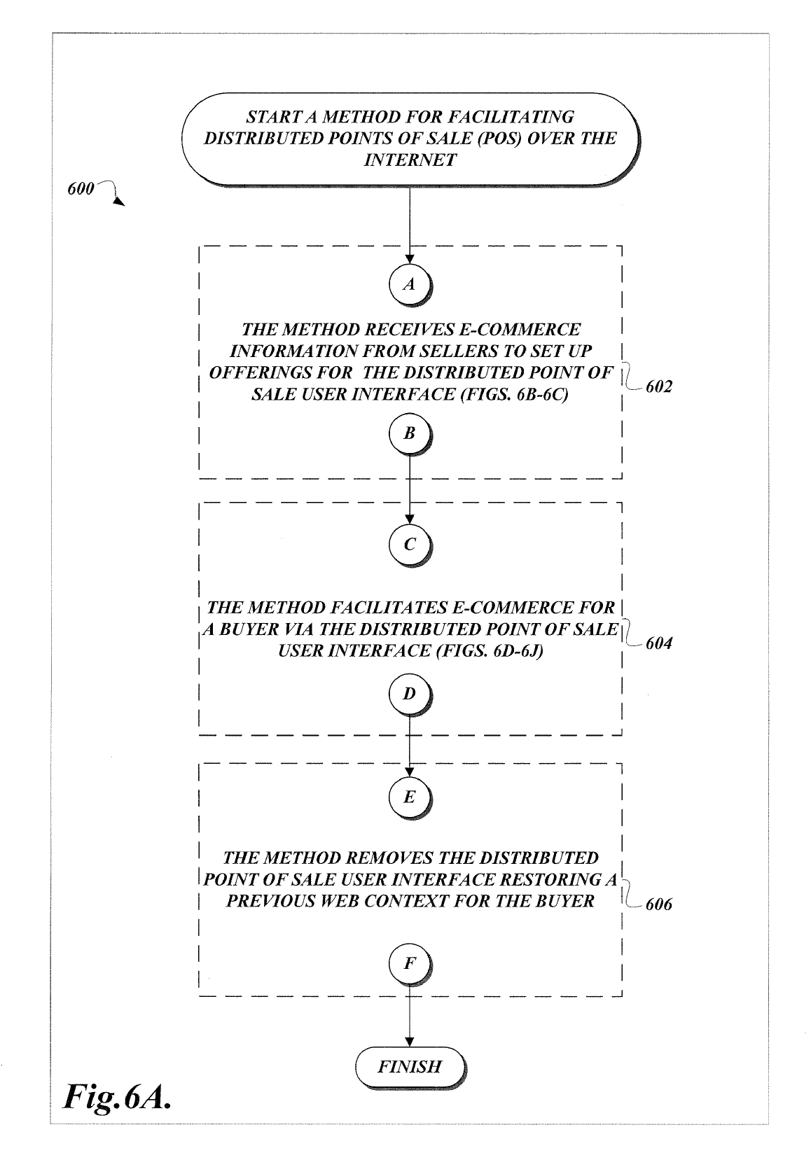

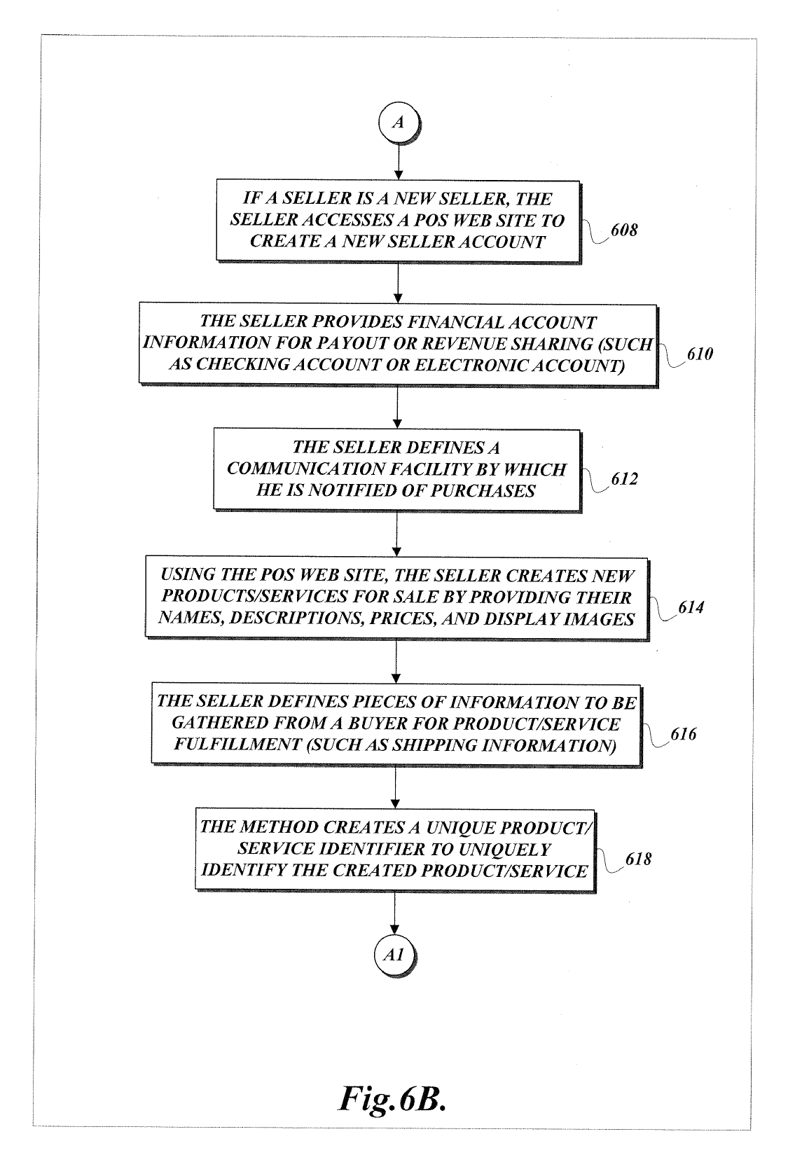

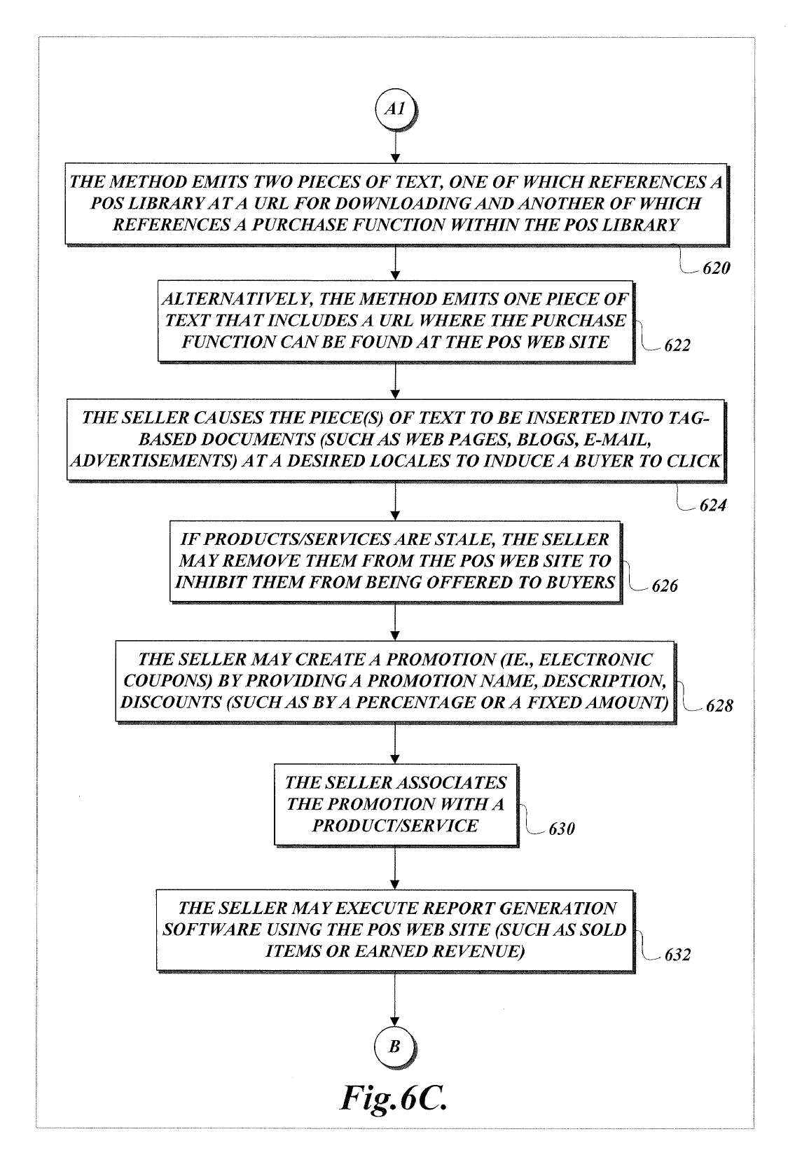

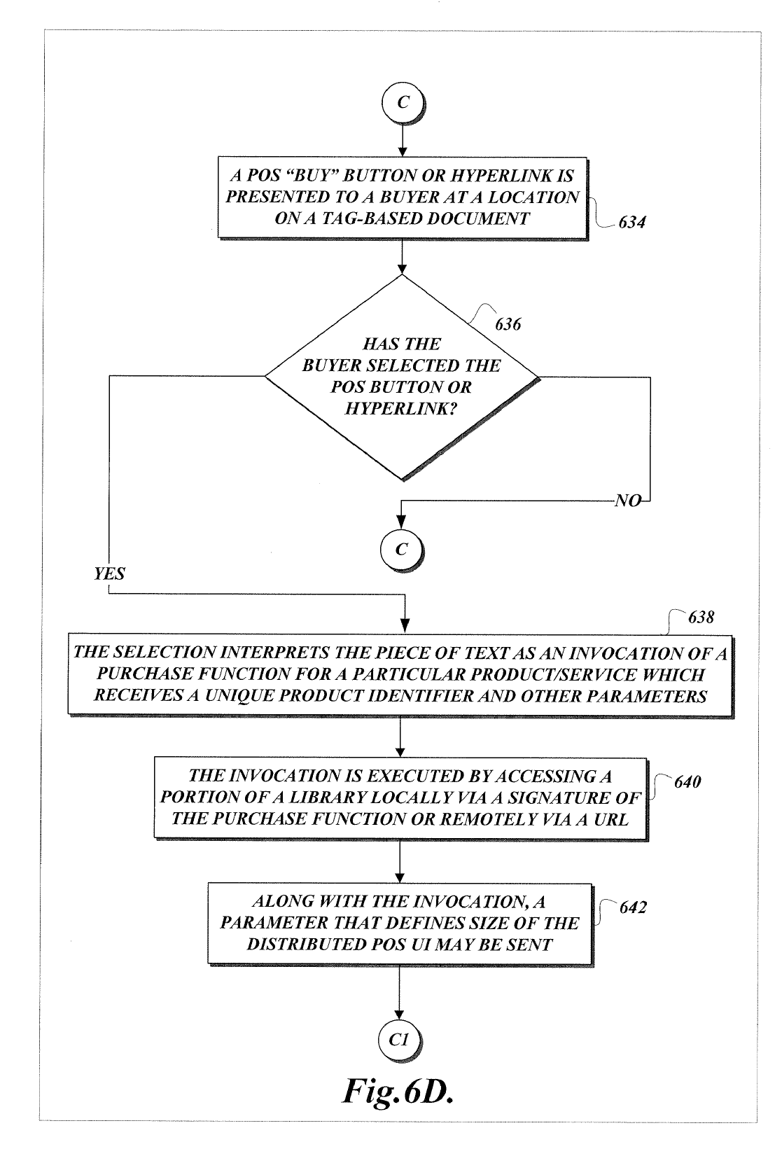

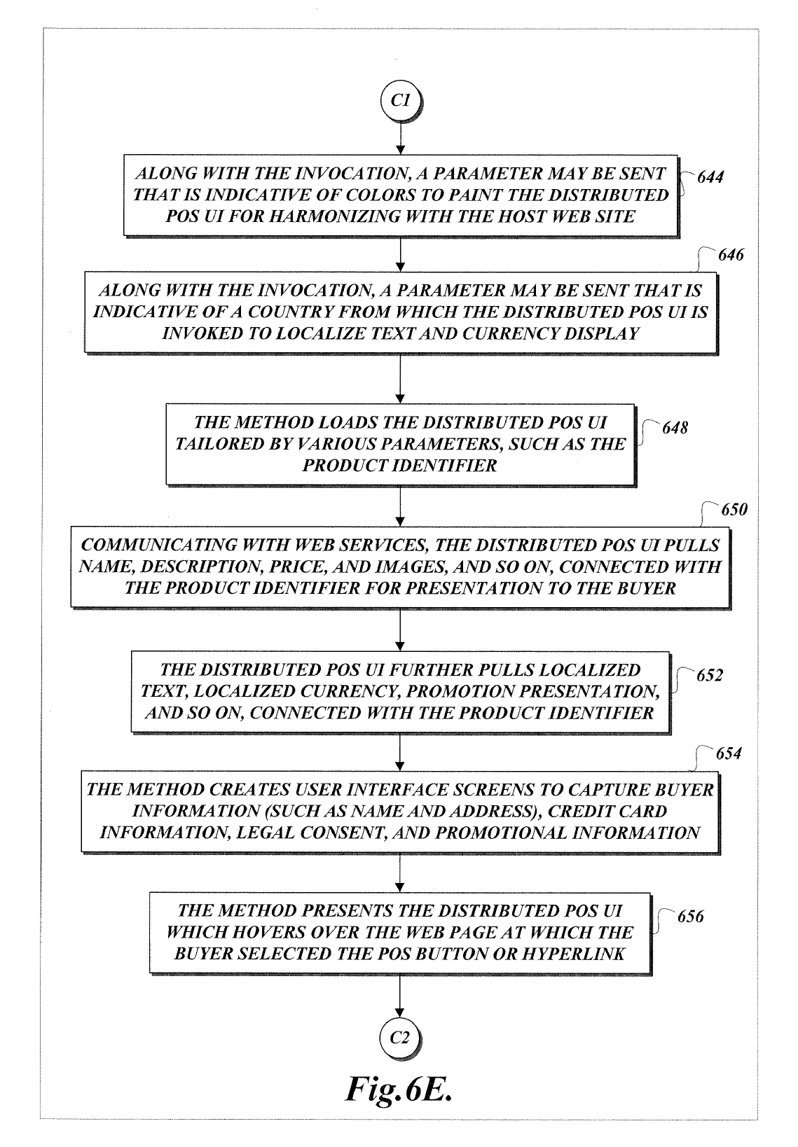

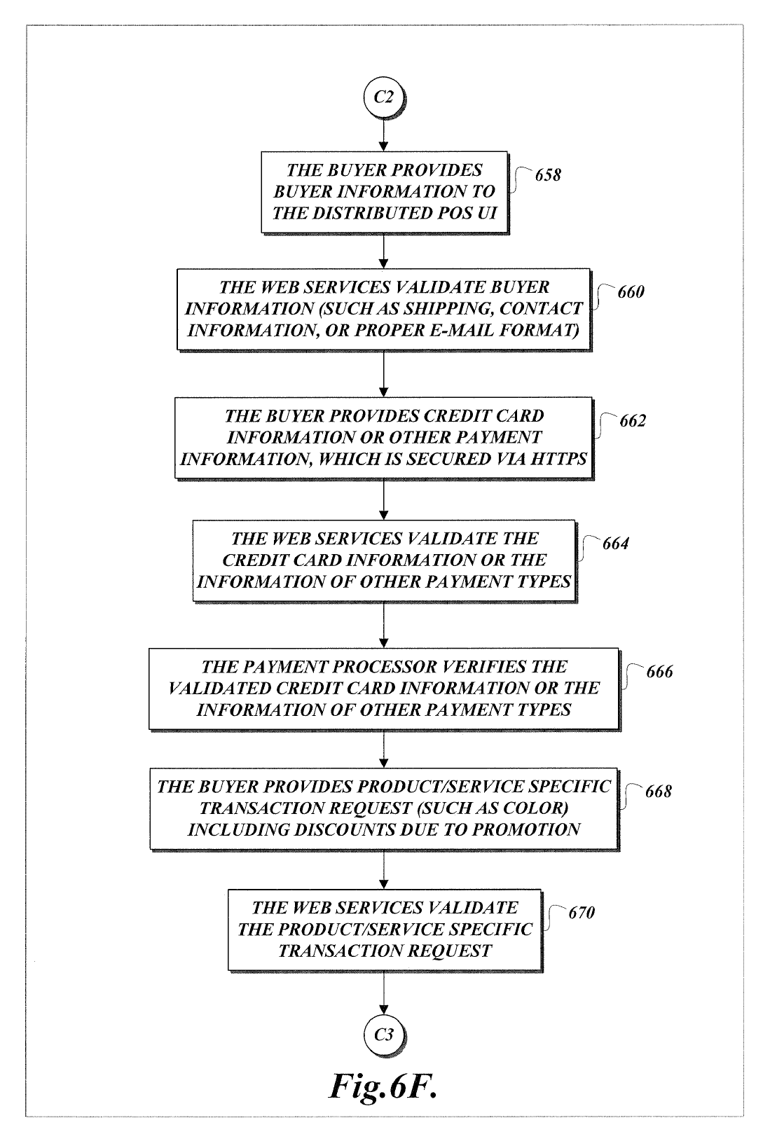

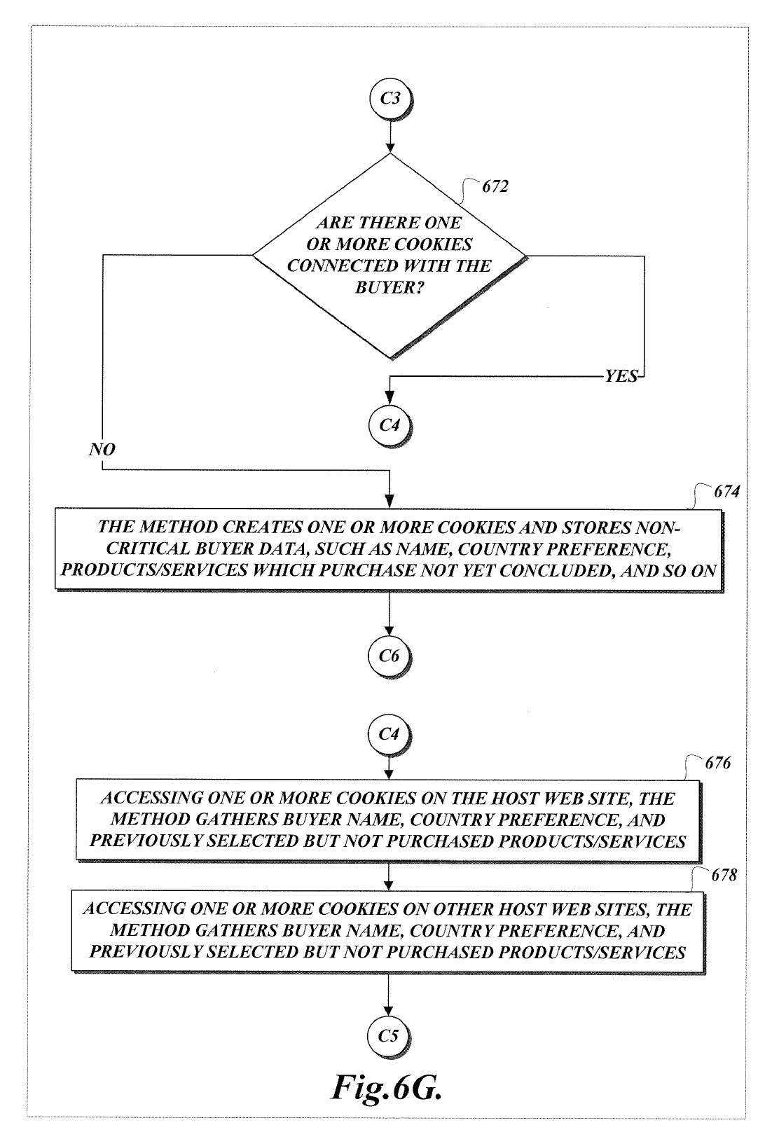

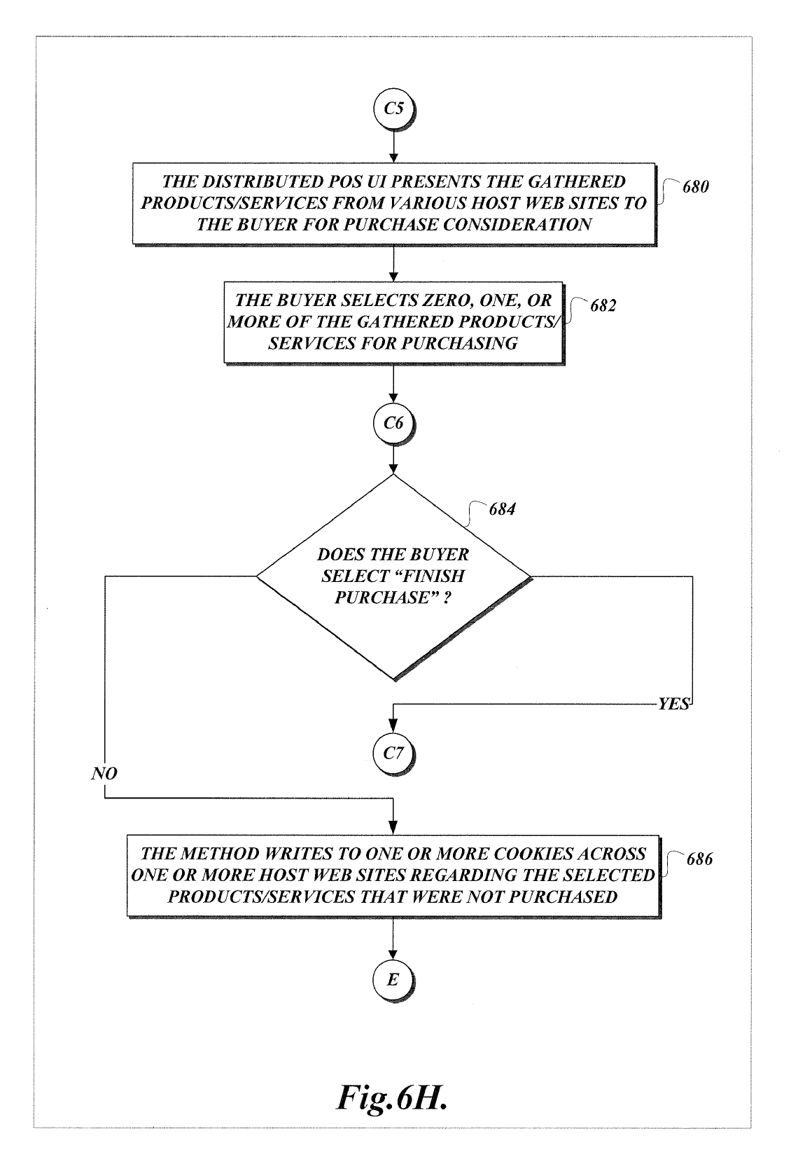

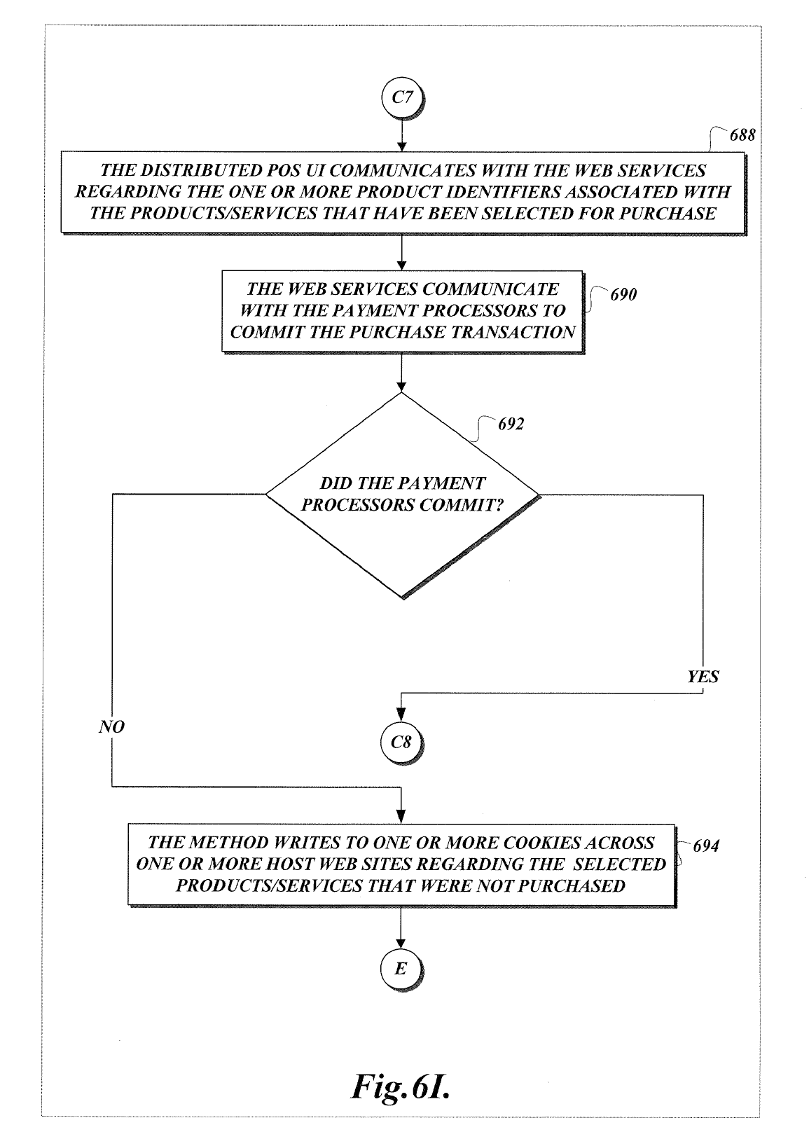

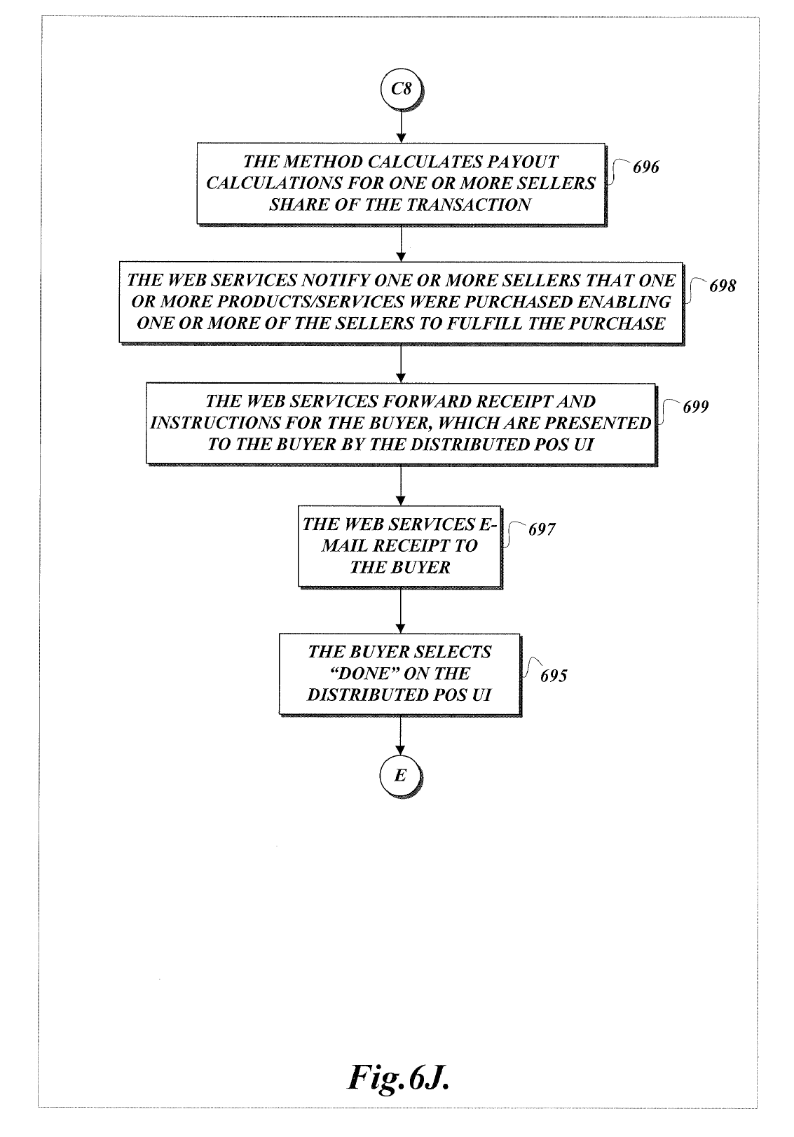

FIGS. 6A-6J illustrate a method 600 for facilitating distributed points of sale (POS) over the Internet. From a start block, the method 600 proceeds to a set of method steps 602, defined between a continuation terminal (“Terminal A”) and an exit terminal (“Terminal B”). The set of method steps 602 describes receiving electronic commerce information from sellers to set up offerings for distributed point of sale software. From Terminal A (FIG. 6B), the method 600 proceeds to block 608, where a seller accesses a distributed point of sale Web site to create a new seller account if the seller is a new seller. At block 610, the seller provides financial account information for payout or revenue sharing (such as a checking account or other electronic account). The seller then defines a communication facility by which he or she is notified of purchases, such as e-mail, and so on. See block 612. Next, at block 614, using the distributed point of sale Web site, which is supported by the back end portion 100a, the seller creates new goods/services for sale by providing their names, descriptions, prices, display images, and so on. The seller defines pieces of information to be gathered from a buyer for product/service fulfillment, such as shipping information, phone number, and so on. See block 616. At block 618, the method creates a unique product/service identifier to uniquely identify the created product/service. The method then continues to another continuation terminal (“Terminal A1”).

From Terminal A1 (FIG. 6C), the method emits two pieces of text, one of which references a library at a particular URL for downloading or accessing and another of which references a purchase function within the library. See block 620. Alternatively, the method 600 emits one piece of text that includes a URL where the purchase function can be found at the distributed point of sale Web site 622. The seller causes the pieces of text to be inserted into tag-based documents (such as Web pages, blogs, pieces of e-mail, and advertisements) at a desired locale to induce a buyer to click. See block 624. At block 626, if goods/services are stale, the seller may use the Web services 118 to remove them from the distributed point of sale Web site to inhibit them from being further offered to buyers. At block 628, the seller may create a promotion, such as electronic coupons, by providing a promotion name, description, discounts, and so on. The discount can be either via a percentage or a fixed amount to be applied. At block 630, the seller associates the promotion with a particular product/service using the unique product/service identifier. Using the Web services 118, the seller may execute report generation software to obtain information such as the number of sold items or the amount of earned revenue. See block 632. The method then continues to Terminal B.

From Terminal B (FIG. 6A), the method 600 proceeds to a set of method steps 604, defined between a continuation terminal (“Terminal C”) and an exit terminal (“Terminal D”). The set of method steps 604 facilitates electronic commerce for a buyer via the distributed point of sale user interface. From Terminal C (FIG. 6D), a distributed point of sale “buy” button or hyperlink is presented to a buyer at a location on a tag-based document. See block 634. Decision block 636 is encountered by the method 600 where a test is performed to determine whether the buyer has selected the distributed point of sale button or hyperlink. If the answer is NO to the test at decision block 636, the method 600 loops back to Terminal C where the above-identified processing steps are repeated. If the answer to the test at decision block 636 is YES, the method 600 continues to block 638 where the selection interprets the piece of text, such as pieces of text 306, 308 as an invocation of a purchase function for a particular product/service that receives a unique product identifier and other parameters. At block 640, the invocation is executed by accessing a portion of a library, such as the library 310, via a signature of the purchase function or remotely via a URL. At block 642, along with the invocation, a parameter may be given that defines size of the distributed point of sale user interface. The method 600 then continues to another continuation terminal (“Terminal C1”).

From Terminal C1 (FIG. 6E), along with the invocation, a parameter may be sent to the Web services 118 that is indicative of colors to paint the distributed point of sale user interface for harmonizing with the host, such as the host Web site. See block 644. At block 646, along with the invocation, another parameter may be sent that is indicative of a country from which the distributed point of sale user interface is invoked to localize text and currency display. For example, if the distributed point of sale user interface is invoked in Russia, suitably the text information that appears on the distributed point of sale user interface is in Russian. At block 648, the method loads the distributed point of sale user interface tailored by various parameters, such as the product identifier, for presentation to the buyer. At block 650, communicating with the Web services 118, the distributed point of sale user interface pulls name, description, price, images, and so on connected with the product identifier for presentation to the buyer. At block 652, the distributed point of sale user interface further pulls localized text, localized currency, promotion presentation, and so on connected with the product identifier. The method at block 654 creates user interface screens to capture billing information, such as name and address, credit card information, legal consent, and promotional information. At block 656, the method presents the distributed point of sale user interface that hovers over the current context of the buyer 502 or appears to be embedded into the current context of the buyer 502, such as a Web page at which the buyer 502 selected the distributed point of sale button or hyperlink. The method then continues to another continuation terminal (“Terminal C2”).

From Terminal C2 (FIG. 6F), the method 600 proceeds to block 658 where the buyer provides buyer information to the distributed point of sale user interface. At block 660, the Web services validates buyer information, such as shipping, contact, proper e-mail format, and so on. At block 662, the buyer provides credit card information or other payment information, which is securely communicated via HTTPS or other suitable secured transfer protocols. At block 664, the Web services validates the credit card information or the information of other payment types. The payment processor further verifies the validated credit card information or information of other payment types at block 666. At block 668, the buyer provides a product/service specific transaction request, such as color of the product, including discounts due to a promotion. At block 670, the Web services validates a product/service specific transaction request. The method then continues to another continuation terminal (“Terminal C3”).

From Terminal C3 (FIG. 6G), the method continues to decision block 672 where a test is performed to determine whether there are one or more cookies connected with the buyer. If the answer to the test at decision block 672 is YES, the method continues to another continuation terminal (“Terminal C4”). If the answer to the test at decision block 672 is NO, the method 600 continues to block 674 where the method creates one or more cookies and stores non-critical billing data, such as name, country preference, goods/services whose purchase is not yet concluded (via the unique product identifier), and so on. The method then continues to another continuation terminal (“Terminal C6”).

From Terminal C4 (FIG. 6G), the method 600 proceeds to block 676 where accessing one or more cookies on the host Web site or other types of tokens, the method 600 gathers buyer name, country preference, and previously selected but not purchased goods/services via their related product identifiers. At block 678, accessing one or more cookies on other host Web sites, the method 600 gathers buyer name, country preference, and previously selected but not purchased goods/services via related product identifiers. The steps of 676 or 678 facilitate the unified shopping cart electronic commerce experience for the buyer 502. The method then continues to another continuation terminal (“Terminal C5”).

From Terminal C5 (FIG. 6H), the distributed point of sale user interface presents the gathered products/services from various host Web sites to the buyer for purchase consideration. See block 680. At block 682, the buyer selects zero, one, or more of the gathered products/services for purchasing. From Terminal C6 (FIG. 6H), a test is performed at decision block 684 to determine whether the buyer selects “finish purchase” as an option on the distributed point of sale user interface. If the answer to the test at decision block 684 is YES, the method 600 proceeds to another continuation terminal (“Terminal C7”). Otherwise, if the answer to the test at decision block 684 is NO, the method 600 proceeds to block 686 where the method writes to one or more cookies across one or more host Web sites regarding the selected goods/services that were not purchased. The method then continues to another continuation terminal (“Terminal E”) where it is assumed that the buyer wishes to terminate the distributed point of sale user interface without purchasing any products/services.

From Terminal C7 (FIG. 6I), the distributed point of sale user interface communicates with the Web services regarding the one or more of the product identifiers associated with the products/services that have been selected for purchase. At block 690, the Web services communicates with the payment processors to commit the purchase transaction. A test is performed at decision block 692 to determine whether the payment processors would commit. If the answer to the test at decision block 692 is YES, the method continues to another continuation terminal (“Terminal C8”). If the answer to the test at decision block 692 is NO, the method continues to block 694 where the method writes to one or more cookies across one or more host Web sites regarding the selected goods/services that were not purchased. The method then continues to Terminal E.

From Terminal C8 (FIG. 6J), the method 600 proceeds to block 696 where the method calculates payout calculations for one or more sellers' share of the transaction. The Web services notify one or more sellers that one or more goods/services were purchased, enabling one or more of the sellers to fulfill the purchase at block 698. At block 699, the Web services forward receipts and instructions for the buyer, which are presented to the buyer by the distributed point of sale user interface. At block 697, the Web services e-mail a receipt to the buyer. The buyer then selects “done” on the distributed point of sale user interface at block 695. The method 600 then continues to Terminal E. From Terminal E (FIG. 6A), the method 600 proceeds to a set of method steps 606 for removing the distributed point of sale user interface and restores the previous Web context for the buyer, and after which the method 600 terminates at an exit terminal (“Terminal F”).

While illustrative embodiments have been illustrated and described, it will be appreciated that various changes can be made therein without departing from the spirit and scope of the invention. For example, the term “products” as used hereinabove and hereinbelow means the inclusion of services and other processes for which a buyer desires to buy and for which a seller desires to sell, and the term “services” as used hereinabove and hereinbelow means the inclusion of products and other articles of manufacture for which a buyer desires to buy and for which a seller desires to sell.

The embodiments of the invention in which an exclusive property or privilege is claimed are defined as follows:

1. A system for facilitating electronic commerce, comprising:
a client computer on which a distributed point of sale user interface is configured to execute by appearing to hover over a tag-based document or appearing to be embedded into the tag-based document, which is not owned by a seller, and to which a buyer navigates without having to further navigate the buyer to another tag-based document so as to facilitate purchase of a product/service by the buyer at the tag-based document.

2. The system of claim 1, further comprising a back end portion which is configured to execute on a network and which defines a programmatic security policy to which the distributed point of sale user interface is included but the tag-based document is excluded.

3. The system of claim 2, further comprising a Web server which is configured to execute at the back end portion of the network to house a Web site for the seller to create the product/service for presentation by the distributed point of sale user interface.

4. The system of claim 3, further comprising a file server which is configured to execute at the back end portion of the network to manage files connected with the seller.

5. The system of claim 4, further comprising Web services which is configured to execute at the back end portion of the network to load pieces of information connected with the product/service for presentation by the distributed point of sale user interface.

6. The system of claim 5, further comprising a database which is configured to execute at the back end portion of the network to store the pieces of information connected with the product/service.

7. The system of claim 1, wherein the distributed point of sale user interface is further configured to present other products/services previously selected but not purchased by the buyer at other tag-based documents so as to allow the buyer to purchase the other products/services as well as the product/service at the tag-based document.

8. A method for facilitating electronic commerce, comprising:
receiving a selection by a buyer on either a hyperlink or a graphical element on a tag-based document that evinces an intention to purchase a product/service; and
presenting a distributed point of sale user interface which appears to hover over the tag-based document or appears to be embedded into the tag-based document, which is not owned by a seller, and to which the buyer navigates without having to further navigate the buyer to another tag-based document so as to facilitate purchase of the product/service by the buyer at the tag-based document.

9. The method of claim 8, further comprising an act of communicating a country code as a parameter to allow text and currency to be localized for a country associated with the country code, the localized text and currency being presented to the buyer by the distributed point of sale user interface.

10. The method of claim 8, further comprising an act of communicating a product identifier that identifies the product/service selected by the buyer for purchase, which act of communicating pulls name, description, price, and images connected with the product/service for presentation by the distributed point of sale user interface.

11. The method of claim 10, further comprising an act of receiving billing information of the buyer and validating the billing information.

12. The method of claim 11, further comprising an act of receiving a communication by the buyer to finish a purchase of the product/service as represented by the product identifier, and an act of requesting a payment processor to commit a transaction to process payments for the purchase.

13. The method of claim 12, further comprising an act of calculating payout for the seller for his share of the purchase.

14. The method of claim 8, further comprising an act of gathering from tokens previously selected by the buyer but not purchased goods/services for presentation by the distributed point of sale user interface to the buyer for purchasing.

15. A computer readable medium having computer-instructions stored thereon for implementing a computer-executable method for facilitating electronic commerce, comprising:
emitting a piece of text that is executable to invoke a distributed point of sale user interface in response to a request for creating a product/service by a seller; and
transmitting pieces of information about the product/service to the distributed point of sale user interface which appears to hover over a tag-based document or appears to be embedded into the tag-based document, which is not owned by the seller, and to which the buyer navigates without having to further navigate the buyer to another tag-based document so as to facilitate purchase of the product/service by the buyer at the tag-based document.

16. The computer-readable medium of claim 15, further comprising an act of receiving financial account information from the seller for revenue sharing.

17. The computer-readable medium of claim 16, further comprising an act of receiving communication facility by which the seller is notified of a purchase by the buyer.

18. The computer-readable medium of claim 17, further comprising an act of receiving name, description, price, and image of the product/service to be presented to the buyer by the distributed point of sale user interface.

19. The computer-readable medium of claim 18, further comprising an act of generating a product identifier that identifies the product/service to be presented to the buyer by the distributed point of sale user interface.

20. The computer-readable medium of claim 15, further comprising an act of defining a promotion to discount a price of the product/service to be presented to the buyer by the distributed point of sale user interface.
